(19) United States
(12) Patent Application Publication
(10) Pub. No.: US 2002/0162276 A1
(43) Pub. Date: Nov. 7, 2002

(54) Anti car-theft device

(76) Inventor: Eyal Biton, Rehovot (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(21) Appl. No.: 09/848,298

(22) Filed: May 4, 2001

(51) Int. Cl. E06B 11/00

(52) U.S. Cl. 49/49; 49/131

(57) ABSTRACT

A device for prevention of theft of a vehicle and for keeping a parking space for a vehicle when the vehicle is not parked in the space. The device is a collapsible barrier controlled by a remote control. It has a novel mechanism of protecting accidental damage to cars and to the barrier itself. Protection is afforded by means of a biasing element built into the device which gives way when accidentally hit by an approaching car and then automatically returns to a vertical position. When the vehicle with the remote control approaches and is about to hit the barrier a warning alarm is sounded, or in another embodiment of this invention, the remote sensor in the device is automatically lowered when it senses the approaching vehicle. In another embodiment of this invention the collapsible barrier is secured onto a ceiling above a parking surface enabling a convenient electric source for the devices and easier maintenance and central control over numerous barriers placed in a large parking facility.

### FIELD AND BACKGROUND OF THE INVENTION

The present invention relates to an anti-theft device and, more particularly, to a collapsible barrier which is used to prevent a car being stolen. Alternately or additionally, the device may be employed to reserve a parking place for a vehicle.

The need for flexible barrier systems to control vehicular access has led to a number of different kinds of barriers. Locked gates have long been used for obstructing vehicles of all types. Gates, however, also obstruct pedestrian traffic, and locks securing the gates are often exposed to the elements and become inoperable over time. The use of keys or combinations further encumbers emergency access, which at best slows down emergency personnel, and at worst bars their access.

U.S. Pat. No. 5,018,902, to Miller et al., describes a bollard which is hinged so that it can fold into a collapsed position. Inside the bollard, a latch bar mates with a protruding locking section rigidly connected to a base, to lock the bollard in an upright, obstructing position. A fireplug wrench is used to actuate the latch bar to disengage it from the locking section, by swinging it about an axis perpendicular to the hinge axis. For automatic reengagement, a hinge is provided in the latch bar, and the portion of the latch bar below the hinge is spring-urged so that it snaps into engagement with the locking section when the bollard housing is brought to its upright, obstructing position. The latch bar needs to be quite large so that a relatively small amount of rotation of the fireplug wrench produces enough movement of a remote portion of the latch base to clear the protruding locking section connected to the base. Consequently, a large movement is required to disengage the latch bar from the locking section. The force needed to disengage the latch bar from the locking section increases over time as a result of corrosion. Therefore release of the bollard becomes increasingly difficult and failure eventually occurs.

U.S. Pat. Nos. 4,576,508 and 4,715,742 to Dickinson, describe bollards which are vertically depressible into underground mounting frames. The locking mechanisms of these bollards may, however, become exposed to the elements, causing them to freeze in position. These bollards are also expensive to install and dependent upon complex actuation mechanisms. The requirement for a hole to receive the retracted bollard is a distinct and inherent disadvantage.

U.S. Pat. No. to Stice, describes a vertically depressible bollard with a substantially self-contained actuation mechanism. This bollard is exceedingly complex, and is dependent upon an electrical power source, which is supplied either through an enclosed battery, or through wires from an outside power source. Battery life and availability of electric current impose severe limits on the use of this device.

U.S. Pat. No. 5,711,110, to Williams, teaches a parking barrier permanently installed in vehicle parking surface, which has a base and legs embedded within a surface. This barrier is set into place by mechanical or electromechanical means through a coded radio frequency transmitter and receiver and in turn, energizes the actuator to rotate the barrier into a horizontal position. The electric system operates on low voltage direct current supplied by a D.C. power supply. The disadvantage to this system is that a there is no give for a frontal accidental head on hit which would cause damage to both the vehicle and to the barrier.

U.S. Pat. No. 6,150,958, to Worsham, teaches a radio-operated parking barrier apparatus including a base housing, a barrier arm including a shaft rotatably mounted in the housing, and a drive assembly disposed within the base housing that includes a pivot arm having a proximal end affixed to the shaft, and a driver having a reciprocally driven plunger movably connected to a distal end of the pivot arm. The back end of the driver is pivotally connected to the floor panel of the base housing to accommodate the vertical movement of the accurate motion that the end of the plunger must necessarily follow in converting the linear movement of the plunger into the rotation movement of the barrier arm around the shaft mounted in the base housing. The driver preferably utilizes a threaded shaft and drive nut to reciprocate the driver in operating the device. The drive assembly provides a simple and reliable linkage between the barrier arm and the base housing. The disadvantage to this system is that a there is no give for a frontal accidental head on hit which would cause damage to both the vehicle and to the barrier.

There is thus an unmet need for, and it would be advantageous to have, a collapsible barrier which is used to prevent a car being stolen and can also be used to guard a parking place for a vehicle when the car is not in the parking place devoid of the above limitations.

### SUMMARY OF THE INVENTION

According to one aspect of the present invention there is provided a device for guarding a parking space of a vehicle within a parking area. The parking area includes at least one parking space and at least one drive aisle. The device comprises (i) a base member securable onto a surface, the base member capable of engaging and retaining a rotatable barrier pivot axis, (ii) a barrier member integrally formed with or joined to the rotatable pivot axis such that rotation of the barrier pivot axis causes a change in a position of the barrier member from a first position to a second position, (iii) a driving mechanism for reversibly rotating the barrier pivot axis; and (iv) a biasing element for retaining the barrier member in the first position, wherein the first position prevents vehicular access to the parking space and the second position permits vehicular access to the parking space.

According to one aspect of the present invention there is provided a device for guarding a parking space of a vehicle within a parking area. The parking area includes at least one parking space and at least one drive aisle. The device comprises (i) a base member securable onto a ceiling, the base member capable of engaging and retaining a rotatable barrier pivot axis (ii) a barrier member integrally formed with or joined to the rotatable pivot axis such that rotation of the barrier pivot axis causes a change in a position of the barrier member from a first position to a second position, and a driving mechanism for reversibly rotating the barrier pivot axis, wherein the first position prevents vehicular access to the parking space and the second position permits vehicular access to the parking space.

According to further features in preferred embodiments of the invention described below the barrier member further includes two arms approximately perpendicular to the pivot axis joined at a proximal end to the pivot axis and joined at a distal end by a bar which is approximately parallel to the barrier pivot axis.

According to still further features in the described preferred embodiments the barrier member is comprised of one arm approximately perpendicular to the pivot axis joined at a proximal end to the pivot axis.

According to still further features in the described preferred embodiments the distal end of the barrier member in the second position is pointing away from the approach drive aisle.

According to still further features in the described preferred embodiments when an external substantially horizontal force is applied in a direction towards the barrier member in the first position, the barrier member moves from the first position towards the second position. When the external horizontal force is discontinued, the biasing element returns the barrier member to the first position.

According to still further features in the described preferred embodiments rotation of the barrier pivot axis is controllable by a remote control mechanism.

According to still further features in the described preferred embodiments the driving mechanism comprises (i) a motor, (ii) a plurality of connected shafts and rods; and (iii) an electrical mechanism for powering of the motor.

According to still further features in the described preferred embodiments the electrical mechanism includes a power source selected from the group consisting of a solar power source, a battery power source or a power source from a vehicle parked in the parking space.

According to still further features in the described preferred embodiments the device further comprises a detection mechanism, the detection mechanism capable of detecting an approaching vehicle. The detection mechanism further comprises a warning mechanism for warning a driver of the approaching vehicle that the barrier member is in the first position.

According to still further features in the described preferred embodiments the barrier member is manually operated in case of a malfunction of the driving mechanism.

According to still further features in the described preferred embodiments wherein resistance of an obstructing object during movement of the barrier member automatically reverses the direction of movement of the barrier member.

According to still further features in the described preferred embodiments the surface is a surface selected from the group consisting of a floor, a parking lot ground, a ceiling, a wall and a post.

According to still further features in the described preferred embodiments the electrical mechanism is powered by an electrical source from the ceiling.

According to still further features in the described preferred embodiments the first position of the barrier member is a vertical position and the second position of the barrier is a horizontal position.

According to still further features in the described preferred embodiments the electrical mechanism is powered by an item selected from the group consisting of a battery and an AC electrical power source.

According to still further features in the described preferred embodiments the device further includes a biasing element for retaining the barrier member in the first position

According to still further features in the described preferred embodiments the AC electric power source is located in the ceiling.

The present invention successfully addresses the shortcomings of the presently known configurations by providing a collapsible barrier which is used to prevent a car being stolen and can also be used to guard a parking place for a vehicle when the car is not in the parking place.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a is a schematic representation of a vehicle approaching a parking space with an anti-car-theft device in a vertical position;

FIG. 1b is a schematic representation of a vehicle in a parking space with an anti-car-theft device in a horizontal position;

FIG. 1c is a schematic representation of an anti-car-theft device in a vertical position;

FIG. 1d is a schematic representation of an anti-car-theft device in a vertical position showing it on its way to being in a horizontal position;

FIG. 1e is a schematic representation of an anti-car-theft device in a horizontal position;

FIG. 2 is an isometric view of an anti-car-theft device in a vertical position viewed from above with the cover removed allowing view of internal working parts;

FIG. 3 is an isometric view of an anti-car-theft device in a horizontal position during exertion of an external horizontal force viewed from above with the cover removed allowing view of internal working parts;

FIG. 4a is a schematic representation of a ceiling mounted anti-car-theft device; and

FIG. 4b is a schematic representation of a covered parking lot with numerous anti-car-theft devices installed.

### DESCRIPTION OF THE PREFERRED EMBODIMENTS

The present invention is of an anti-theft device. Specifically, the present invention is of a collapsible barrier that can be used to prevent a car from being stolen. The present invention is further of a device which can be used to guard a parking place for a vehicle when the car is not in the parking place.

The principles and operation of an anti-theft device and parking space saver according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the term “surface ” includes but is not limited to floor, a parking lot ground, a ceiling, a wall and a post.

For purposes of this specification and the accompanying claims, the term “first position” generally refers to a perpendicular or vertical position of the barrier member in relationship to the barrier base member and “second position” generally refers to a parallel or horizontal position of the barrier member in relationship to the barrier base member.

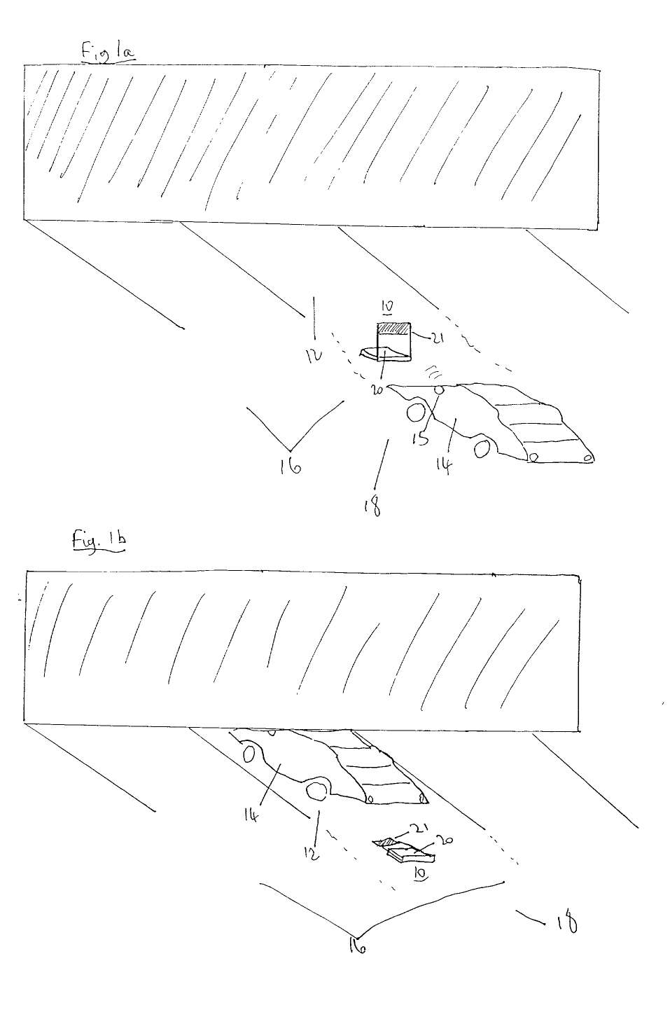

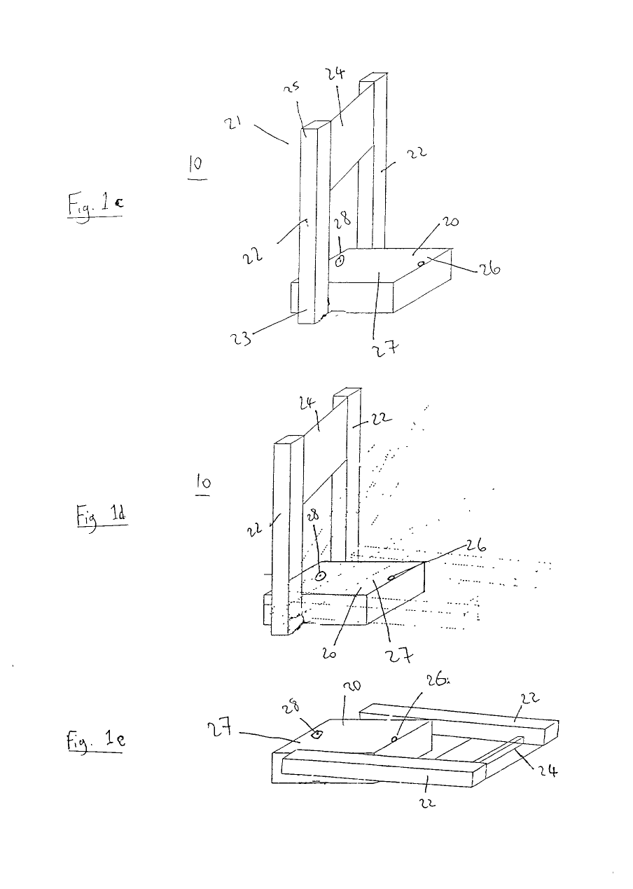

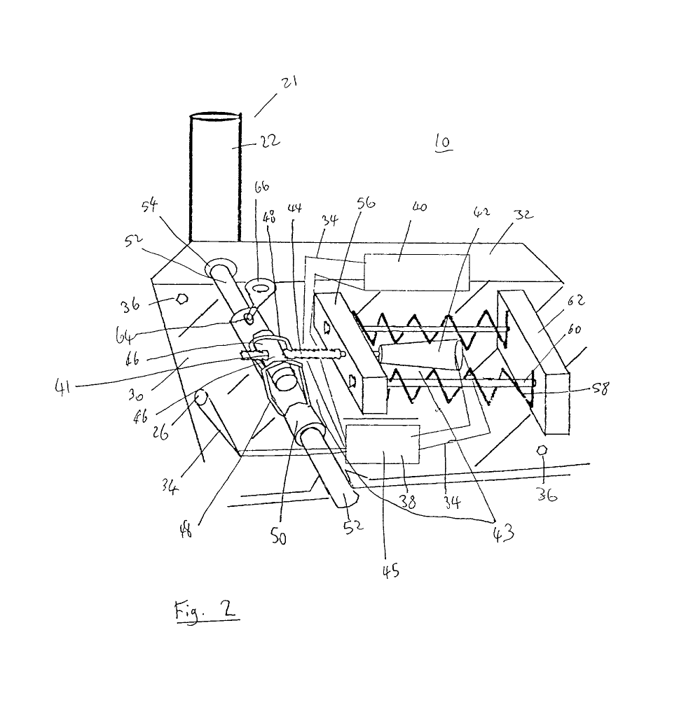

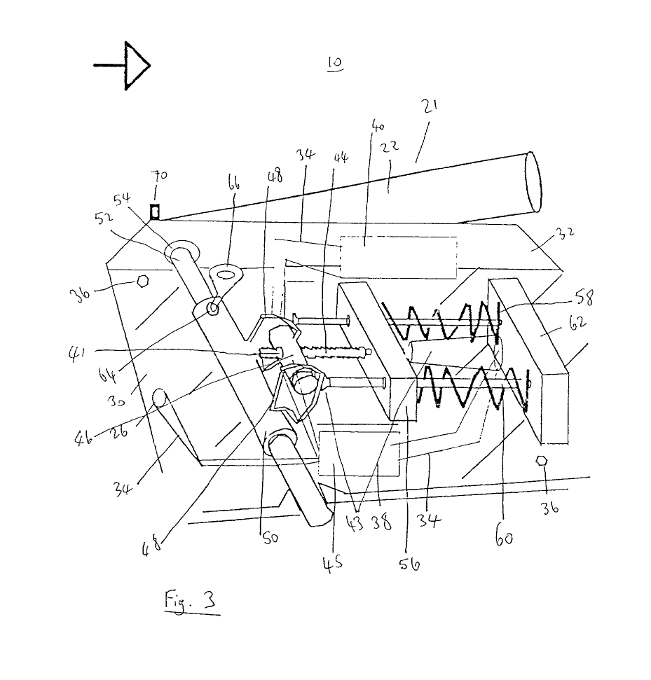

Referring now to the drawings, FIG. 1a illustrates a device for guarding a parking space 12 of a vehicle 14 within a parking area 16. Parking area 16 includes at least one parking space 12 and at least one drive aisle 18. Device 10 can be positioned at the entrance to a parking space 12 as illustrated which would provide protection for both a parked vehicle 14 and a parking space 12 in the absence of a vehicle 14, or somewhere else inside parking space 12 where it would serve the purpose of reserving a parking space. In the alternative position within parking space 12, device 10 will remain in the horizontal position and vehicle 14 is parked above device 10. Device 10 includes a base member 20 secured onto or into a surface. Base member 20 engages and retains a barrier pivot axis 52 (FIG. 2). A barrier member 21 is integrally formed with barrier pivot axis 52. A driving mechanism 43 reversibly rotates barrier pivot axis 52 from a “first” position to a “second” position. FIG. 1a depicts a vehicle 14 approaching device 10, which is in a “first” or vertical position. FIG. 1b depicts vehicle 14 in parking space 12 after having driven over device 10 with barrier member 21 in a “second” or horizontal position. FIGS. 1c, 1d and 1e depict barrier member 21 moving from a “first” or a vertical to a “second” or a horizontal position. The distal end 25 of barrier member 21 in the horizontal position is pointing away from the approach drive aisle 18.

Barrier member 21 may be, for example, comprised of two arms 22 approximately perpendicular to the pivot axis 52 joined at a proximal end 23 to pivot axis 52 and joined at a distal end 25 by a bar 24 which is approximately parallel to barrier pivot axis 52. In a preferred embodiment bar 24 serves as a sign such as a “reserved” sign. Alternatively, the two arms 22 are integrally formed with both barrier pivot axis 52 and bar 24.

In another preferred embodiment, barrier member 21 is comprised of one arm approximately perpendicular to pivot axis joined at a proximal end to the pivot axis 52.

In a preferred embodiment of this invention, a biasing element 58 retains barrier member 21 in the first position. When an external substantially horizontal force is applied in a direction towards barrier member 21 in the first position, barrier member 21 rotates about barrier pivot axis 52 at an acute angle from the first position to the second position. FIG. 3 illustrates device 10 in a second position during exertion of an external horizontal force. When the external horizontal force is discontinued, biasing element 58 returns barrier member 21 to the first position.

In a preferred embodiment of this invention, the movement of barrier member 21 is controlled by a remote control mechanism including a remote control sensor 26 which detects a signal emitted by remote control device 15. Remote control mechanisms are commercially available and one ordinarily skilled in the art will be capable of selecting a commercially available mechanism and integrating it into the present invention.

FIG. 2 illustrates device 10 shown here from above with the lid 27 removed to expose internal working parts. Driving mechanism 43 includes a motor 42. Operation of motor 42 rotates a threaded rod 44 in one direction in order moves barrier member 21 from a first position to a second position. Rotation of threaded rod 44 in an opposite direction by motor 42 moves barrier member 21 from a second position to a first position. Threaded rod 44 passes through a transfer rod 46. Transfer rod 46 has a matching female threaded hole 41 through which threaded rod 44 traverses. Transfer rod 46 penetrates a pair of transfer clips 48. Transfer clips 48 are permanently connected to a pivot axis sheath 50. Pivot axis sheath 50 functions as a female sheath over the barrier pivot axis 52. A pivot-connecting pin 66 through matching holes 64 in both pivot axis sheath 50 and pivot axis 52 joins pivot axis sheath 50 and pivot axis 52. Barrier pivot axis 52 protrudes through base member 20 through exit hole 54 and is connected to the arm 22 of barrier member 21. Only part of one arm 22 is shown here to expose additional parts.

In operation, when barrier member 21 is in the first position motor 42 rotates threaded rod 44. As transfer rod 46 is not free to rotate because it is held in place by transfer clips 48, threaded rod 44 advances through the female threading 41 of transfer rod 46 thus causing transfer rod 46 to move perpendicularly down threaded rod 44 toward motor 42. This in turn causes transfer clips 48 to rotate perpendicularly to threaded rod 44, which causes pivot axis sheath 50 and pivot axis 52 to rotate in the same direction. Pivot axis 52 being integrally connected to barrier arm 22 causes barrier arm 22 to descend into a second position as in FIG. 1e.

On the other hand, when barrier member 21 is in the second position motor 42 rotates threaded rod 44 in the opposite direction. As transfer rod 46 is not free to rotate because it is held in place by transfer clips 48, threaded rod 44 moves through the female threading of transfer rod 46 in the opposite direction thus actually causing transfer rod 46 to move perpendicularly up threaded rod 44 away from motor 42. This in turn causes transfer clips 48 to rotate (in the opposite direction to the above mentioned descending of barrier arm 22), which as a result cause pivot axis sheath 50 and pivot axis 52 to rotate. Pivot axis 52 being integrally connected to barrier arm 22 causes barrier arm 22 to ascend into a first position.

The purpose of pivot connecting pin 66 and of having both pivot axis sheath 50 and pivot axis 52 is in case of a malfunction preventing driving mechanism 43 from moving the barrier member on the barrier pivot axis from the first position to the second position or vice-versa. In case of a malfunction a person removes the base member lid 27 by opening base member lid lock 28 and removing pivot connecting pin 66. Barrier member 22 can then be manually pulled up or pushed down as needed.

A device in another preferred embodiment without the abovementioned malfunctioning function would not need pivot connecting pin 66 or pivot axis sheath 50 or matching holes 64 and in such a case, pivot axis 52 is connected directly to transfer clips 48.

When there is resistance of an obstructing object during its movement, barrier member 22 automatically reverses the direction of movement by motor 42.

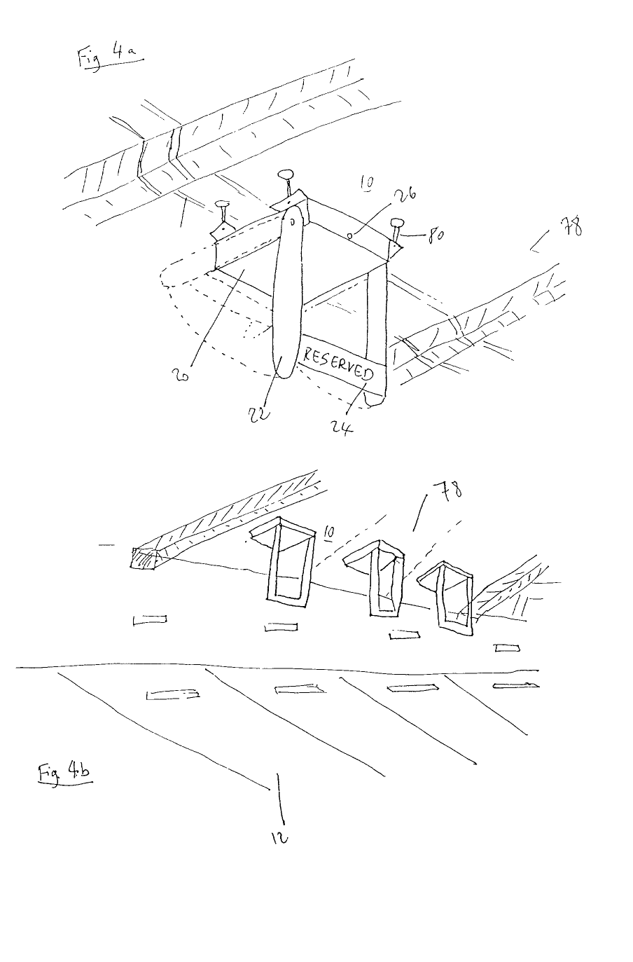

Electrical mechanism 45 can be solar-powered or battery 40 powered (rechargeable or disposable), and in one preferred embodiment is recharged from vehicle 14, parked in parking space 12. In another preferred embodiment (FIG. 4a) ceiling mounted device 10 is powered by an alternating current source in the ceiling of the parking area. Electric switch-box 38 (FIG. 3) governs the entire electric operations of device 10. Electric wiring 38 relays electricity to motor 42 and from sensor 26.

Remote control sensor 26 in another embodiment of this invention detects approaching vehicle 14. When vehicle 14 comes in close proximity to device 10 from either side and barrier member 21 is in a first position an audible alarm warning of a collision between vehicle 14 and barrier member 21 is sounded emanating either from an alarm in device 10 or from the remote control device 15 in vehicle 14.

In a preferred embodiment remote control device 15 in vehicle 12 or alternatively a unit carried by a person constantly emits a signal. When vehicle 14 approaches device 10 remote control sensor 26 detects approaching vehicle 14 and automatically lowers barrier member 21 from a first position to a second position, thus avoiding any accidental collision by vehicle 14 with remote control device 15. Sensors capable of detecting approaching objects are commonplace in many alarms and are well known to those skilled in the art of moving object detection.

In a preferred embodiment, there is a built-in mechanism for protecting both device 10 and cars inadvertently colliding with barrier member 21 while in the first position. Threaded rod 44 passes through a moveable transfer block 56 through which at least one biasing spring rod 60 (shown here in FIG. 2 as two rods) also pass. The distal ends of biasing spring rod 60 are permanently attached to a stationary end block 62. A biasing element such as a spring 58 connects the back of moveable transfer block 56 to the front of stationary end block 62. When an external horizontal force is applied to barrier member 21, for example by a car backing up into barrier member 21 from the approach drive aisle 18, barrier member 21 rotates in an acute angle towards the second position. It does this as barrier arm 22 rotates, barrier arm 22 also rotates pivot axis 52, pivot axis sheath 50 and transfer clips 48. Transfer clips 48 then is physically push transfer rod 46 back towards stationary end block 62, causing moveable transfer block 56 to move closer to stationary end block 62 along biasing spring rod 60. This in turn tensions spring 58 as illustrated in FIG. 3. Spring 58 is configured to be able to give only to strong forces such as vehicles and not to give way for a person pushing barrier member 21 down.

When the external horizontal force is discontinued, biasing element 58 returns barrier member 21 to a first position by pushing moveable transfer block 56 away from stationary end block 62 along biasing spring rod 60 back into its original position before the external force was applied. This in turn pushes transfer rod 48 which causes transfer clips 48 to rotate, which in turn rotates pivot axis sheath 50 and barrier pivot axis 52 causing barrier arm 22 to return to its first position.

In a preferred embodiment brake 70 physically prevents barrier member 21 from descending into a second position pointing away from parking space 12. When a vehicle 14 enters the parking space by forcing device 10 into its second position, the vehicle will be stuck in the parking space until the device owner will release him.

Another preferred embodiment is FIG. 5 illustrates device 10 installed onto a ceiling 78 in a covered structure. In this embodiment device 10 is either mounted onto a ceiling or roof assembly 78 or suspended from a ceiling or a roof assembly to allow for ceiling obstructions such as conduit or pluming lines. Device 10 is suspended with the aid of a threaded rod assembly with base plates 80. This embodiment has many advantages. Device 10 can be connected to the electric wiring 82 which runs through the ceiling anyway for example for lighting purposes without having to alter parking surface 12. When the barrier members 21 are in a horizontal position, then mechanical sweeping of surfaces is much easier.

Numerous devices 10 can also be operated through a centralized control panel with audible alarm sounding in a parking office.

The present invention proposes some innovative design improvements making the barrier a stronger and safer barrier. In addition the present invention teaches a device for protecting a parking place within a covered parking lot, whereby a barrier is attached to a ceiling where it would be convenient to obtain an electric power source within the ceiling as well as making parking lot parking surface easy to clean.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A device for guarding a parking space of a vehicle within a parking area which includes at least one parking space and at least one drive aisle, the device comprising:
(a) a base member securable onto a surface, said base member capable of engaging and retaining a rotatable barrier pivot axis;
(b) a barrier member integrally formed with or joined to said rotatable pivot axis such that rotation of said barrier pivot axis causes a change in a position of said barrier member from a first position to a second position;
(c) a driving mechanism for reversibly rotating said barrier pivot axis; and
(d) a biasing element for retaining said barrier member in said first position;
wherein said first position prevents vehicular access to the parking space and said second position permits vehicular access to the parking space.

2. The device of claim 1, wherein said barrier member comprises two arms approximately perpendicular to said barrier pivot axis, each of said arms joined at a proximal end to said barrier pivot axis and joined at a distal end by a bar which is approximately parallel to said barrier pivot axis.

3. The device of claim 1, wherein said barrier member comprises one arm approximately perpendicular to pivot axis, said arm joined at a proximal end to said pivot axis.

4. The device of claim 1, wherein said distal end of said barrier member in said second position is pointing away from the approach drive aisle.

5. The device of claim 4, wherein when an external substantially horizontal force is applied in a direction towards said barrier member in said first position, said barrier member moves from said first position towards said second position.

6. The device of claim 5, wherein when said external horizontal force is discontinued, said biasing element returns said barrier member to said first position.

7. The device of claim 1, wherein rotation of said barrier pivot axis is controllable by a remote control mechanism.

8. The device of claim 1, wherein said driving mechanism comprises:
(i) a motor;
(ii) a plurality of connected shafts and rods; and
(iii) an electrical mechanism for powering of said motor.

9. The device of claim 8, wherein said electrical mechanism comprises a power source selected from the group consisting of a solar power source, a battery power source and a power source from a vehicle parked in said parking space.

10. The device of claim 1, further comprising a detection mechanism, said detection mechanism capable of detecting an approaching vehicle.

11. The device of claim 10, wherein said detection mechanism further comprises a warning mechanism for warning a driver of said approaching vehicle that said barrier member is in said first position.

12. The device of claim 1, wherein said barrier member is manually operable in case of a malfunction of said driving mechanism.

13. The device of claim 1, wherein resistance of an obstructing object during movement of said barrier member automatically reverses the direction of movement of said barrier member.

14. The device of claim 1, wherein said surface is a surface selected from the group consisting of a floor, a parking lot ground, a ceiling, a wall and a post.

15. The device of claim 1, wherein said first position of said barrier member is a vertical position and said second position of said barrier is a horizontal position.

16. A device for guarding a parking space of a vehicle within a parking area which includes at least one parking space and at least one drive aisle, the device comprising:
(a) a base member securable onto a ceiling, said base member capable of engaging and retaining a rotatable barrier pivot axis;
(b) a barrier member integrally formed with or joined to said rotatable pivot axis such that rotation of said barrier pivot axis causes a change in a position of said barrier member from a first position to a second position; and
(c) a driving mechanism for reversibly rotating said barrier pivot axis;
wherein said first position prevents vehicular access to the parking space and said second position permits vehicular access to the parking space.

17. The device of claim 16, wherein said driving mechanism comprising:
(a) a motor;
(b) a plurality of connected shafts and rods; and
(c) an electrical mechanism for powering of said motor.

18. The device of claim 17, wherein said electrical mechanism is powered by an item selected from the group consisting of a battery and an AC electrical power source.

19. The device of claim 16, further comprising a biasing element for retaining said barrier member in said first position.

20. The device of claim 16, wherein said first position of said barrier member is a vertical position and said second position of said barrier is a horizontal position.

21. The device of claim 18, wherein AC electric power source is located in said ceiling.
